(19) United States
(12) Patent Application Publication
(10) Pub. No.: US 2019/0226925 A1
(43) Pub. Date: Jul. 25, 2019

(54) TORQUE SENSOR

(71) Applicant: KYB Corporation, Tokyo (JP)

(72) Inventor: Hideo MAEHARA, Gifu (JP)

(21) Appl. No.: 16/333,225

(22) PCT Filed: Oct. 2, 2017
(86) PCT No.: PCT/JP2017/035883

§ 371 Date: Mar. 14, 2019

(30) Foreign Application Priority Data
Oct. 5, 2016 (JP) 2016-197317

(51) Int. Cl. G01L 3/10

(52) U.S. Cl. CPC G01L 3/101

(57) ABSTRACT

A torque sensor includes a detector assembly configured to detect a density of a magnetic flux. The detector assembly includes a case configured to house a magnetic detector and a board, the case being attached to a housing, and a connector integrally formed with the case. The case includes a fitting portion configured to be fitted into an opening portion formed in the housing, and a brim portion fastened to the housing. The connector is formed such that a center axis of the connector is offset from the center axis of the fitting portion in a radial direction of the torsion bar, and the connector is formed such that an end surface on a side opposite to a connection port to be connected to a mating connector is offset toward the housing from a contact surface of the brim portion with the housing.

### TECHNICAL FIELD

The present invention relates to a torque sensor.

### BACKGROUND ART

JP2011-257225A discloses a non-contact type torque sensor for detecting a steering torque acting on a steering shaft by a magnetic force as a torque sensor provided in an electric power steering device of a vehicle.

The torque sensor disclosed in JP2011-257225A includes a sensor holder for housing a magnetic sensor and a board, and the sensor holder is provided with a connector for connecting the board and an external controller (see FIGS. 3 and 4(a) of JP2011-257225A).

### SUMMARY OF INVENTION

In the torque sensor disclosed in JP2011-257225A, since the connector provided in the sensor holder extends in a direction parallel to the board and is formed to protrude from the sensor holder, the entire sensor holder is enlarged.

Accordingly, the sensor holder may interfere with vehicle-side components when mounting the electric power steering device into the vehicle. If the sensor holder is enlarged as just described, the mountability of the electric power steering device into the vehicle is deteriorated.

The present invention aims to improve the mountability of an electric power steering device into a vehicle.

According to one aspect of the present invention, a torque sensor for detecting a torque acting on a torsion bar coupling a first shaft and a second shaft rotatably supported in a housing includes: a magnetic generation unit configured to rotate together with the first shaft; a rotating magnetic circuit unit configured to rotate together with the second shaft; and a detector assembly configured to detect a density of a magnetic flux introduced from the magnetic generation unit through the rotating magnetic circuit unit according to torsional deformation of the torsion bar. The detector assembly includes: a magnetic detector configured to detect the magnetic flux density; a board having the magnetic detector connected to the board; a nonmagnetic case configured to house the magnetic detector and the board, the case being attached to the housing; and a connector configured to hold a pin connected to the board, the connector being integrally formed with the case. The case includes: a fitting portion configured to be fitted into an opening portion formed in the housing, the fitting portion having a center axis extending in a radial direction of the torsion bar; and a brim portion extending in a direction perpendicular to an outer peripheral surface of the fitting portion, the brim portion being fastened to the housing. The connector is formed such that a center axis of the connector is offset from the center axis of the fitting portion in a radial direction of the torsion bar, and the connector is formed such that an end surface on a side opposite to a connection port to be connected to a mating connector is offset toward the housing from a contact surface of the brim portion with the housing.

### BRIEF DESCRIPTION OF DRAWINGS

FIG. 1 is a sectional view of an electric power steering device to which a torque sensor according to an embodiment of the present invention is applied,

FIG. 2 is a perspective view of a rotating magnetic circuit unit,

FIG. 3 is a perspective view of a detector assembly,

FIG. 4 is a perspective view of the detector assembly with a case and a connector omitted,

FIG. 5 is a view showing a positional relationship of magnetic flux collecting yokes and a magnetic sensor,

FIG. 6 is a front view of a first housing,

FIG. 7 is a front view of the first housing with the detector assembly omitted,

FIG. 8 is a plan view of the first housing, and

FIG. 9 is a sectional view along line A-A in FIG. 6.

### DESCRIPTION OF EMBODIMENT

Hereinafter, a torque sensor 100 according to an embodiment of the present invention is described with reference to the drawings.

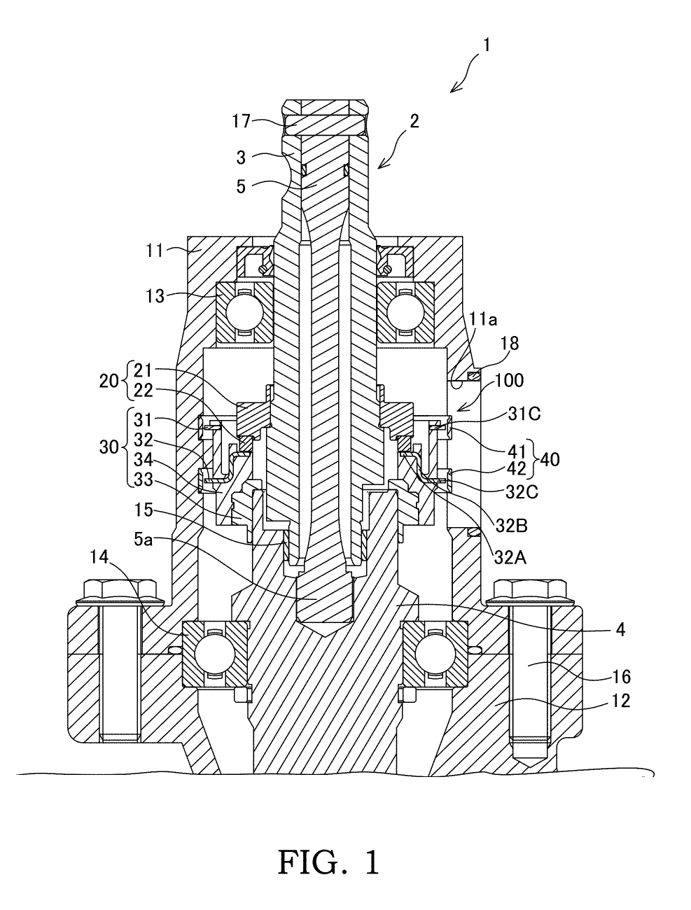

First, an electric power steering device 1 to which the torque sensor 100 is applied is described with reference to FIG. 1. The electric power steering device 1 is a device mounted in a vehicle to assist the steering of a steering wheel by a driver.

The electric power steering device 1 includes a steering shaft 2 coupled to the steering wheel and configured to rotate according to the rotation of the steering wheel and a rack shaft configured to turn wheels according to the rotation of the steering shaft 2.

The steering shaft 2 includes an input shaft 3 serving as a first shaft configured to rotate according to the steering of the steering wheel by the driver, an output shaft 4 serving as a second shaft configured to link the wheels to the rack shaft configured to turn, and a torsion bar 5 configured to couple the input shaft 3 and the output shaft 4.

A pinion gear meshed with a rack gear formed on the rack shaft is formed on a lower part of the output shaft 4. When the steering wheel is steered, the steering shaft 2 rotates, the rotation thereof is translated into a linear motion of the rack shaft by the pinion gear and the rack gear, and the wheels are turned via knuckle arms. It should be noted that a pinion shaft meshed with the rack shaft and the output shaft 4 may be coupled via an intermediate shaft.

The electric power steering device 1 includes, as an assist mechanism for assisting the steering of the driver, a worm wheel coupled to the output shaft 4, a worm shaft meshed with the worm wheel, and an electric motor configured to rotationally drive the worm shaft. The electric power steering device 1 applies a steering assist torque to the output shaft 4 by the electric motor.

The input shaft 3 is rotatably supported in a first housing 11 made of metal via a rolling bearing 13. The output shaft 4 is rotatably supported in a second housing 12 made of metal via a rolling bearing 14. A sliding bearing 15 is interposed between a lower end side of the input shaft 3 and an upper end side of the output shaft 4. The input shaft 3 and the output shaft 4 are supported in the first and second housings 11, 12 rotatably on the same axis. The first and second housings 11, 12 are fastened via bolts 16.

The input shaft 3 is formed into a hollow cylindrical shape, and the torsion bar 5 is coaxially housed inside the input shaft 3. An upper end part of the torsion bar 5 is coupled to an upper end part of the input shaft 3 via a pin 17. A lower end part of the torsion bar 5 projects from a lower end opening of the input shaft 3 and is coupled to the output shaft 4 via a serration 5a. The torsion bar 5 transmits a steering torque input to the input shaft 3 via the steering wheel to the output shaft 4 and is twisted and deformed about an axis according to the steering torque.

The electric power steering device 1 is provided with the non-contact type torque sensor 100 for detecting a steering torque applied to the torsion bar 5 on the basis of a rotational angle difference between the input shaft 3 and the output shaft 4. The torque sensor 100 is described in detail below.

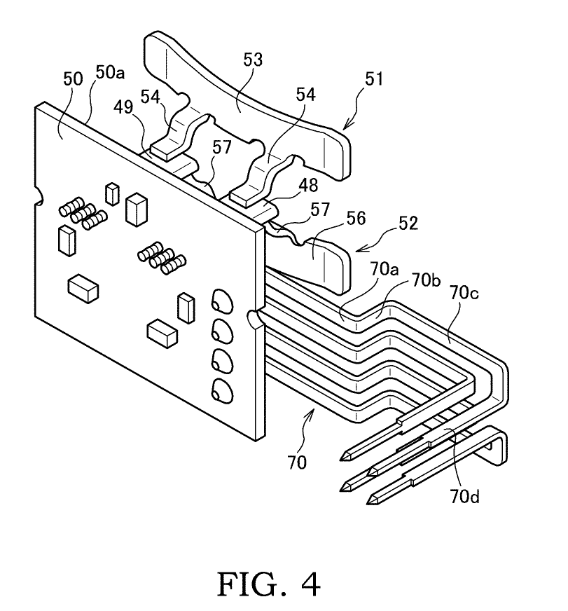

As shown in FIG. 1, the torque sensor 100 includes a magnetic generation unit 20 fixed to the input shaft 3 and configured to rotate together with the input shaft 3, a rotating magnetic circuit unit 30 fixed to the output shaft 4 and configured to rotate together with the output shaft 4, a fixed magnetic circuit unit 40 fixed to the first housing 11, and a first magnetic sensor 48 and a second magnetic sensor 49 (see FIG. 4) serving as a magnetic detector for detecting a density of a magnetic flux introduced to the fixed magnetic circuit unit 40 from the magnetic generation unit 20 through the rotating magnetic circuit unit 30 according to torsional deformation of the torsion bar 5. The torque sensor 100 detects the steering torque acting on the torsion bar 5 on the basis of outputs of the first and second magnetic sensors 48, 49.

Instead of the above configuration, the magnetic generation unit 20 may be fixed to the output shaft 4 to rotate together with the output shaft 4, and the rotating magnetic circuit unit 30 may be fixed to the input shaft 3 to rotate together with the input shaft 3.

The magnetic generation unit 20 includes an annular back yoke 21 to be press-fitted into the input shaft 3 and an annular ring magnet 22 to be bonded to the lower end surface of the back yoke 21.

The ring magnet 22 is a permanent magnet for generating magnetism in a rotation axis direction of the input shaft 3. The ring magnet 22 is a multipole magnet formed by magnetizing a hard magnetic body in the rotation axis direction and includes twelve magnetic poles formed to have an equal width in a circumferential direction. That is, six N poles and six S poles are alternately disposed in the circumferential direction on the upper and lower end surfaces of the ring magnet 22. The number of the magnetic poles formed on the end surface of the ring magnet 22 is arbitrarily set in a range more than or equal to two.

An upper magnetic pole surface, which is the upper end surface of the ring magnet 22, is fixed to the lower end surface of the back yoke 21 via adhesive. Since a back yoke 24 is formed by a soft magnetic body, the back yoke 24 is magnetized by a magnetic field applied by the ring magnet 22 and attracted to the ring magnet 22. As just described, the back yoke 21 and the ring magnet 22 are bonded by an adhesive force of the adhesive and a magnetic force. The back yoke 21 has a function as a coupling member for coupling the ring magnet 22 to the input shaft 3 and a function as a yoke for connecting adjacent magnetic poles of the ring magnet 22 and introducing a magnetic flux, and concentrates the magnetic force on a lower magnetic pole surface, which is the lower end surface of the ring magnet 22.

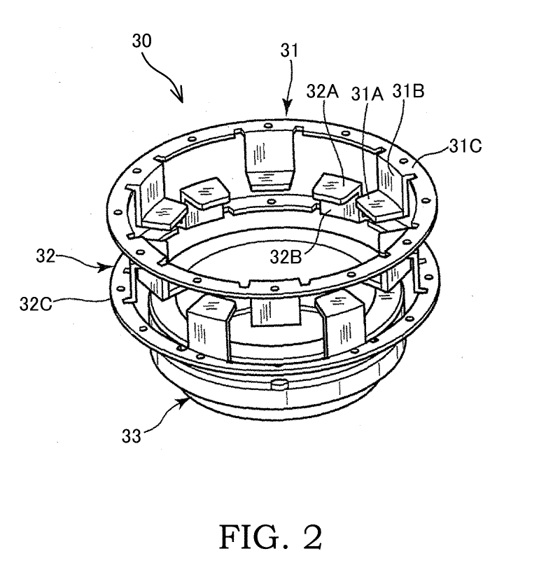

As shown in FIGS. 1 and 2, the rotating magnetic circuit unit 30 includes a first soft magnetic ring 31 and a second soft magnetic ring 32 to which the magnetic flux generated from the ring magnet 22 is introduced, an attaching member 33 to be attached to the output shaft 4, and a molded resin 34 for fixing the first and second soft magnetic rings 31, 32 to the attaching member 33.

The first soft magnetic ring 31 includes an annular first magnetic path annular portion 31C, six first magnetic path column portions 31B projecting downward from the first magnetic path annular portion 31C, and first magnetic path tip portions 31A respectively bent inward from the lower ends of the first magnetic path column portions 31B and facing the lower end surface of the ring magnet 22. The second soft magnetic ring 32 includes an annular second magnetic path annular portion 32C, six second magnetic path column portions 32B projecting upward from the second magnetic path annular portion 32C, and second magnetic path tip portions 32A respectively bent inward from the upper ends of the second magnetic path column portions 32B and facing the lower end surface of the ring magnet 22.

The first and second soft magnetic rings 31, 32 are formed by press-working. The first and second soft magnetic rings 31, 32 may be formed by casting, sintering, or the like without limitation to press-working.

The first and second magnetic path tip portions 31A, 32A are in the form of flat plates. The first and second magnetic path tip portions 31A, 32A are alternately arranged at equal intervals in the circumferential direction about a rotation axis of the torsion bar 5 on the same plane perpendicular to that rotation axis. Further, the first and second magnetic path tip portions 31A, 32A are arranged such that center lines thereof extending in radial directions of the torsion bar 5 point to boundaries between the N and S poles of the ring magnet 22 in a neutral state where no torque is acting on the torsion bar 5.

The first and second magnetic path column portions 31B, 32B are respectively in the form of flat plates and extend in a rotation axis direction of the torsion bar 5. The first magnetic path column portions 31B are arranged to surround the outer peripheral surface of the ring magnet 22 with a predetermined clearance defined therebetween. The first magnetic path column portions 31B are provided to prevent short-circuiting of a magnetic flux of the ring magnet 22. The second magnetic path column portions 32B extend in a direction opposite to the first magnetic path column portions 31B along the rotation axis of the torsion bar 5.

The first and second magnetic path annular portions 31C, 32C are arranged on planes perpendicular to the rotation axis of the torsion bar 5 and formed into an annular shape continuous over the entire circumference. The shapes of the first and second magnetic path annular portions 31C, 32C are not limited to these shapes and may be C shapes partially formed with a slit.

The first magnetic path annular portion 31C is arranged above the lower end surface of the ring magnet 22 and the second magnetic path annular portion 32C is arranged below the ring magnet 22. That is, the ring magnet 22 is arranged between the first and second magnetic path annular portions 31C, 32C in the rotation axis direction of the torsion bar 5.

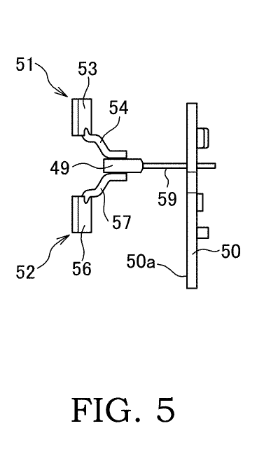

As shown in FIG. 1, the fixed magnetic circuit unit 40 includes an annular first magnetic flux collecting ring 41 provided along the outer periphery of the first magnetic path annular portion 31C of the first soft magnetic ring 31, an annular second magnetic flux collecting ring 42 provided along the outer periphery of the second magnetic path annular portion 32C of the second soft magnetic ring 32, a first magnetic flux collecting yoke 51 (see FIGS. 4 and 5) arranged in contact with the outer peripheral surface of the first magnetic flux collecting ring 41 and a second magnetic flux collecting yoke 52 (see FIGS. 4 and 5) arranged in contact with the outer peripheral surface of the second magnetic flux collecting ring 42.

The first and second magnetic flux collecting rings 41, 42 are formed into a C shape partially formed with a slit and are caulked and fixed to the inner peripheral surface of the first housing 11. The inner peripheral surface of the first magnetic flux collecting ring 41 is facing the first magnetic path annular portion 31C of the first soft magnetic ring 31, and the inner peripheral surface of the second magnetic flux collecting ring 42 is facing the second magnetic path annular portion 32C of the second soft magnetic ring 32.

As just described, the first and second magnetic flux collecting rings 41, 42 are arranged on the outer periphery of the rotating magnetic circuit unit 30 and have a function of introducing a magnetic flux toward the first and second magnetic sensors 48, 49 by alleviating the runout of the rotating magnetic circuit unit 30 and the influence of eccentricity.

It should be noted that the first and second magnetic flux collecting rings 41, 42 are not essential and may be omitted. In such a case, the first magnetic flux collecting yoke 51 is arranged along the first magnetic path annular portion 31C of the first soft magnetic ring 31 and the second magnetic flux collecting yoke 52 is arranged along the second magnetic path annular portion 32C of the second soft magnetic ring 32.

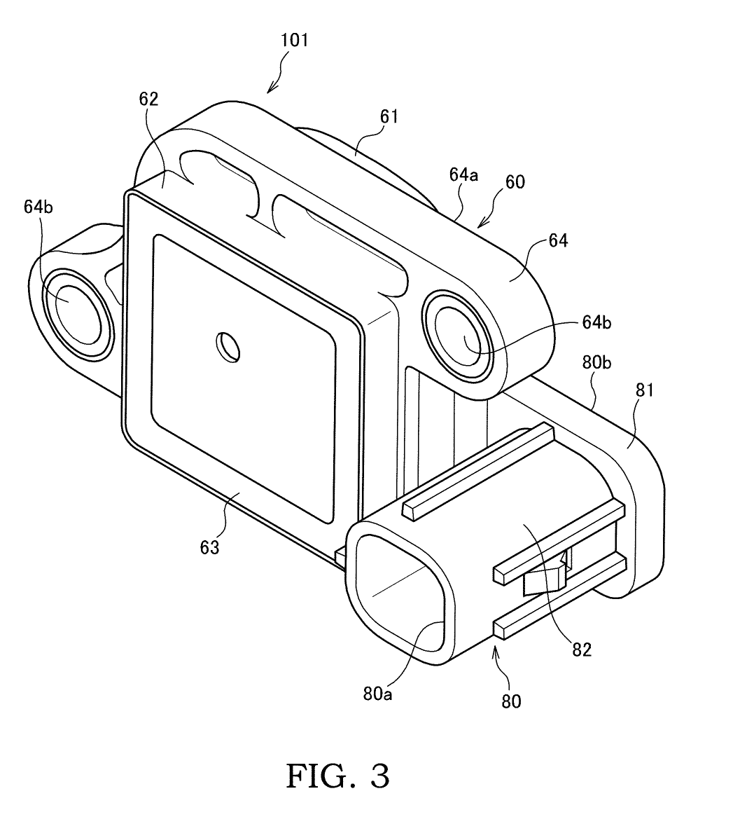

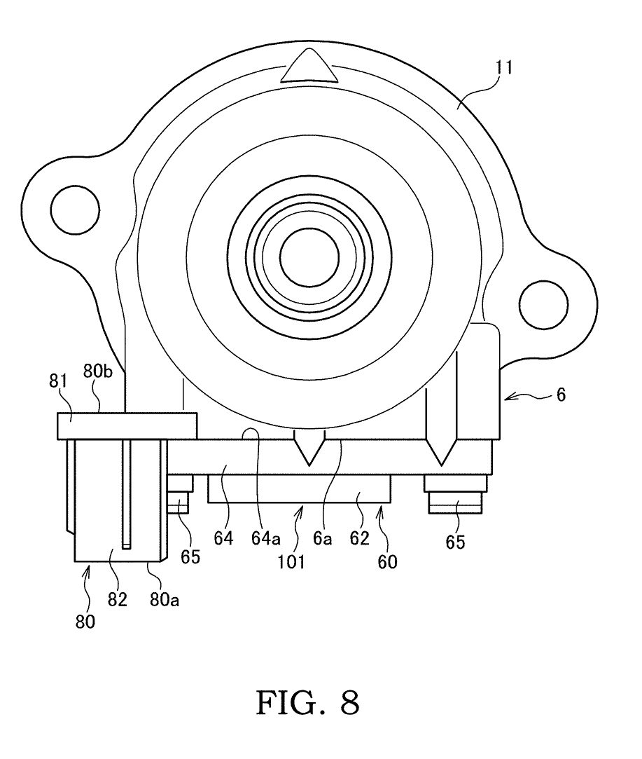

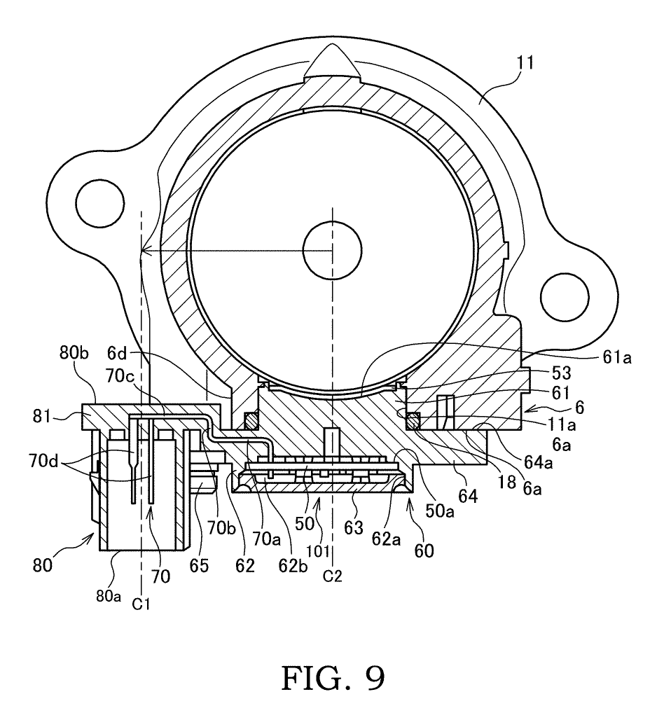

The first and second magnetic flux collecting yokes 51, 52 are provided in a case 60 together with the first and second magnetic sensors 48, 49 and constitute a detector assembly 101 shown in FIG. 3. The detector assembly 101 is described in detail with reference to FIGS. 3 to 9 below. It should be noted that, not the cross-sections, but the projection planes of a board 50 and a pin 70 are shown in a sectional view shown in FIG. 9.

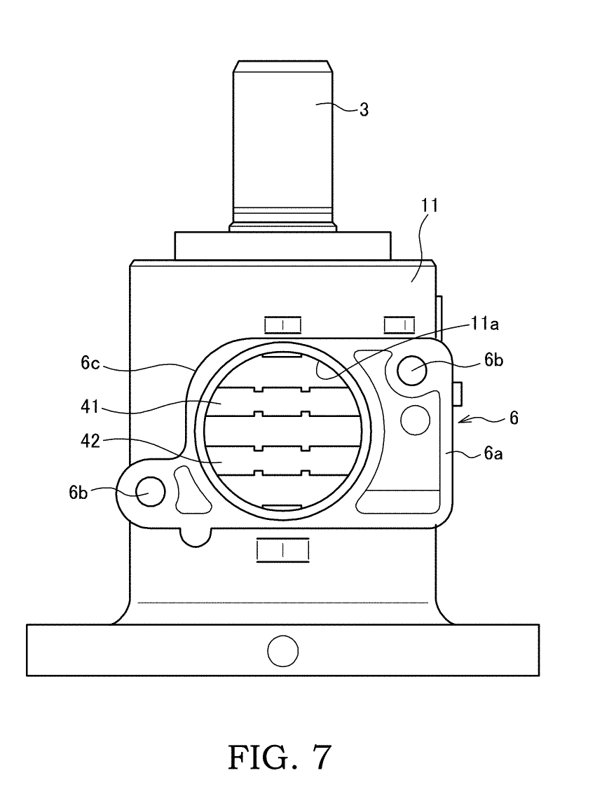

The detector assembly 101 is for detecting a density of a magnetic flux introduced from the ring magnet 22 through the rotating magnetic circuit unit 30 according to the torsional deformation of the torsion bar 5 and is attached to the first housing 11. It should be noted that FIGS. 1 and 7 show a state where the detector assembly 101 is not attached.

As shown in FIGS. 3 to 5, the detector assembly 101 includes the first and second magnetic sensors 48, 49 configured to detect the magnetic flux density, the board 50 having the first and second magnetic sensors 48, 49 connected thereto, the first and second magnetic flux collecting yokes 51, 52 constituting a part of the fixed magnetic circuit unit 40 and configured to introduce a magnetic flux from the rotating magnetic circuit unit 30 to the first and second magnetic sensors 48, 49, the resin-made case 60 houses the magnetic sensors 48, 49 and the board 50 and attached to the first housing 11, and a connector 80 configured to hold the pin 70 connected to the board 50.

As shown in FIGS. 4 and 5, the first and second magnetic sensors 48, 49 are connected to the board 50 via a pin 59 extending perpendicularly from a surface 50a of the board 50. The first and second magnetic sensors 48, 49 are arranged with a predetermined distance from each other.

Hall elements are used as the magnetic sensors 48, 49. The Hall element outputs a voltage corresponding to the density of the magnetic flux passing therethrough as a signal. The magnetic sensors 48, 49 output voltages corresponding to the density magnitude and direction of the magnetic flux to an EPS controller for controlling the drive of the electric power steering device 1 through the board 50.

The torque sensor 100 is provided with two magnetic sensors 48, 49 to diagnose a failure of the torque sensor 100 by comparing output voltages of the both. In other words, if a failure of the torque sensor 100 is not diagnosed using the magnetic sensors, one magnetic sensor may be provided.

The first and second magnetic flux collecting yokes 51, 52 have the same shape. As shown in FIGS. 4 and 5, the first magnetic flux collecting yoke 51 includes a yoke body 53 having an inner peripheral surface in contact with the outer peripheral surface of the first magnetic flux collecting ring 41 and a pair of leg portions 54 formed to project from the yoke body 53. Similarly, the second magnetic flux collecting yoke 52 includes a yoke body 56 having an inner peripheral surface in contact with the outer peripheral surface of the second magnetic flux collecting ring 42 and a pair of leg portions 57 formed to project from the yoke body 56.

The first and second magnetic flux collecting yokes 51, 52 are integrally molded with the case 60 by injection molding.

The yoke bodies 53, 56 are arranged parallel to each other at a predetermined distance in an axial direction of the torsion bar 5.

The pair of leg portions 54 of the first magnetic flux collecting yoke 51 and the pair of leg portions 57 of the second magnetic flux collecting yoke 52 are arranged at a predetermined distance in a circumferential direction of the rotating magnetic circuit unit 30. The leg portions 54 and the leg portions 57 are formed to extend in directions toward each other from end surfaces of the yoke bodies 53, 56 that face each other, and tip parts of the leg portions 54 and those of the leg portions 57 face each other with magnetic gaps, which are predetermined clearances, defined therebetween. That is, a pair of magnetic gaps arranged in the circumferential direction are formed between the first and second magnetic flux collecting yokes 51, 52. The first and second magnetic sensors 48, 49 are respectively arranged in the pair of magnetic gaps.

The magnetic flux collecting yokes 51, 52 have a function of collecting the magnetic flux from the rotating magnetic circuit unit 30 to the magnetic sensors 48, 49.

The pin 70 is for outputting an arithmetic processing result in a circuit on the board 50 to outside. As shown in FIGS. 4 and 9, one end side of the pin 70 is connected to the surface 50a of the board 50 and the other end side thereof is held in the connector 80. The pin 70 is integrally molded with the case 60 and the connector 80 by injection molding.

Next, the case 60 and the connector 80 are described with reference to FIGS. 3 to 9.

The case 60 includes a fitting portion 61 to be fitted into an opening portion 11a (see FIGS. 1 and 7) formed in the first housing 11, a board housing portion 62 arranged to be exposed from the first housing 11 and configured to house the board 50 inside, a cover 63 configured to seal an opening portion 62a of the board housing portion 62 and a flange portion 64 serving as a brim portion to be fastened to the first housing 11.

The connector 80 is for electrically connecting the board 50 and the EPS controller. The connector 80 is integrally formed with the case 60.

The case 60 and the connector 80 are made of resin, but may be formed of a nonmagnetic material without limiting the material thereof to resin.

As shown in FIG. 7, an attachment base 6 to which the detector assembly 101 is attached is formed on the outer peripheral surface of the first housing 11. The attachment base 6 is formed with an attachment surface 6a in the form of a flat surface with which the flange portion 64 of the case 60 is fastened in contact and the circular opening portion 11a open in the attachment surface 6a.

The opening portion 11a is formed to penetrate through the attachment base 6 and the first housing 11. The magnetic flux collecting rings 41, 42 provided in the first housing 11 are facing the opening portion 11a in a state where the detector assembly 101 is not attached to the attachment base 6 (state shown in FIGS. 1 and 7).

The fitting portion 61 is formed into a cylindrical shape and the outer peripheral surface thereof is fitted to the inner peripheral surface of the opening portion 11a (see FIG. 9). With the fitting portion 61 fitted in the opening portion 11a, a center axis of the fitting portion 61 extends in a radial direction of the torsion bar 5. An O-ring 18 (see FIGS. 1 and 9) for sealing between the inner peripheral surface of the opening portion 11a and the outer peripheral surface of the fitting portion 61 is provided on the inner peripheral surface of the opening portion 11a. In this way, the entrance of mud water and the like into the first housing 11 from outside through a clearance between the opening portion 11a and the fitting portion 61 is prevented.

The inner peripheral surfaces of the yoke bodies 53, 56 of the magnetic flux collecting yokes 51, 52 are arranged in an exposed manner on a surface of the fitting portion 61 facing the inside of the first housing 11, i.e. on a tip surface 61a of the fitting portion 61 (see FIG. 9). Thus, with the fitting portion 61 fitted in the opening portion 11a, the yoke bodies 53, 56 are in contact with the outer peripheral surfaces of the magnetic flux collecting rings 41, 42 arranged in the first housing 11 to constitute magnetic paths between the magnetic flux collecting rings 41, 42 and the magnetic flux collecting yokes 51, 52.

The board housing portion 62 is internally provided with a space 62b for housing the board 50. The board 50 is housed into the space 62b through the opening portion 62a. The board 50 is fixed in the space 62b by heat caulking and adhesive. The board housing portion 62 has a rectangular outer shape in conformity with the shape of the board 50.

The flange portion 64 extends in a direction perpendicular to the outer peripheral surface of the fitting portion 61 and has a contact surface 64a in contact with the attachment surface 6a of the attachment base 6. The flange portion 64 is formed with a pair of bolt insertion holes 64b into which fastening bolts 65 are inserted. The pair of bolt insertion holes 64b are formed at positions symmetrical with respect to a center axis of the fitting portion 61. The attachment base 6 is formed with screw holes 6b (see FIG. 7), into which the bolts 65 are screwed, at positions corresponding to the pair of bolt insertion holes 64b.

The connector 80 is formed into a bottomed tube shape including a bottom portion 81 and a hollow cylindrical portion 82. The hollow cylindrical portion 82 has an axial length longer than a diameter. A part of the pin 70 is held in the bottom portion 81 and extends in an axial direction of the hollow cylindrical portion 82 in the hollow cylindrical portion 82. The connector 80 is a male connector and connected to a mating female connector. By connecting the connector 80 and the mating connector, the board 50 and the EPS controller are electrically connected.

As shown in FIG. 9, the connector 80 is integrally formed on a lateral part of the case 60 with a center axis C1 thereof offset from a center axis C2 of the fitting portion 61. That is, the center axis C1 of the connector 80 and the center axis C2 of the fitting portion 61 deviate from each other. Specifically, the connector 80 is formed such that the center axis C1 is offset from the center axis C2 of the fitting portion 61 in a radial direction of the torsion bar 5. In this way, the center axis C1 of the connector 80 is offset from the center axis C2 of the fitting portion 61, and the center axis C1 of the connector 80 and the center axis C2 of the fitting portion 61 extend in parallel. Thus, as compared to the case where the connector 80 is integrally formed with the case 60 such that the center axis C1 extends in a direction perpendicular to the center axis C2 of the fitting portion 61, the detector assembly 101 has a smaller width and is compact. That is, the connector 80 is formed without largely protruding from the case 60 in a width direction (direction perpendicular to the center axis C2 of the fitting portion 61) of the case 60.

The center axis C1 of the connector 80 needs not be perfectly parallel to the center axis C2 of the fitting portion 61 and may be offset in a state oblique to the center axis C2. However, a mode in which the center axis C1 is parallelly offset from the center axis C2 is preferable since the detector assembly 101 can be compactly configured.

Further, the connector 80 is integrally formed with the case 60 in such an orientation as a connection port 80a to be connected to the mating connector does not face the outer peripheral surface of the first housing 11. Also, the connector 80 is formed such that a bottom surface 80b, which is an end surface on a side opposite to the connection port 80a, is offset toward the first housing 11 from the contact surface 64a of the flange portion 64. As just described, the contact surface 64a of the flange portion 64 and the bottom surface 80b of the connector 80 are formed not on the same plane, but in a stepped manner.

As shown in FIG. 7, a part of the attachment base 6 facing the bottom surface 80b of the connector 80 is partially cut to form a cutout portion 6c. Thus, although the contact surface 64a of the flange portion 64 and the bottom surface 80b of the connector 80 are formed in a stepped manner, the bottom surface 80b of the connector 80 does not interfere with the attachment base 6.

By offsetting the bottom surface 80b of the connector 80 toward the first housing 11 from the contact surface 64a of the flange portion 64, the hollow cylindrical portion 82 of the connector 80 is arranged along a side surface 6d (see FIG. 9) of the attachment base 6, and the bottom surface 80b of the connector 80 is arranged in proximity to the outer peripheral surface of the first housing 11. An offset amount (deviation amount) of the bottom surface 80b of the connector 80 from the contact surface 64a of the flange portion 64 can be increased up to a position where the bottom surface 80b does not interfere with the outer peripheral surface of the first housing 11.

Since the bottom surface 80b of the connector 80 is offset toward the first housing 11 from the contact surface 64a of the flange portion 64 as just described, the connector 80 can be arranged as close to the first housing 11 as possible. Thus, the protrusion of the connector 80 toward a back surface side of the case 60 can be suppressed, wherefore the detector assembly 101 can be compactly attached to the first housing 11.

The bottom surface 80b of the connector 80 can be offset toward the first housing 11 from the contact surface 64a of the flange portion 64 because of the shape of the pin 70. The shape of the pin 70 is described below.

As shown in FIGS. 4 and 9, the pin 70 includes a first parallel portion 70a formed parallel to the board 50, a first perpendicular portion 70b formed perpendicular to the board 50 and extending toward the first housing 11, a second parallel portion 70c formed parallel to the board 50 and extending in a direction away from the board 50, and a second perpendicular portion 70d formed perpendicular to the board 50 and extending in a direction away from the first housing 11. As just described, a part of the pin 70 includes a bent portion bent toward the first housing 11.

The second perpendicular portion 70d is formed to project from the bottom portion 81 of the connector 80 and extends toward the connection port 80a in the hollow cylindrical portion 82.

The second parallel portion 70c is located at the housing side with respect to the contact surface 64a of the flange portion 64. That is, a part of the pin 70 is located at the housing side with respect to the contact surface 64a of the flange portion 64. Since the part of the pin 70 is located at the housing side with respect to the contact surface 64a of the flange portion 64 as just described, the bottom surface 80b of the connector 80 can be offset toward the first housing 11 from the contact surface 64a of the flange portion 64.

The detector assembly 101 configured as described above is attached to the first housing 11 by tightening the bolts 65 into the bolt insertion holes 64 and the screw holes 6b with the fitting portion 61 of the case 60 fitted in the opening portion 11a of the attachment base 6 and the contact surface 64a of the flange portion 64 held in surface contact with the attachment surface 6a of the attachment base 6.

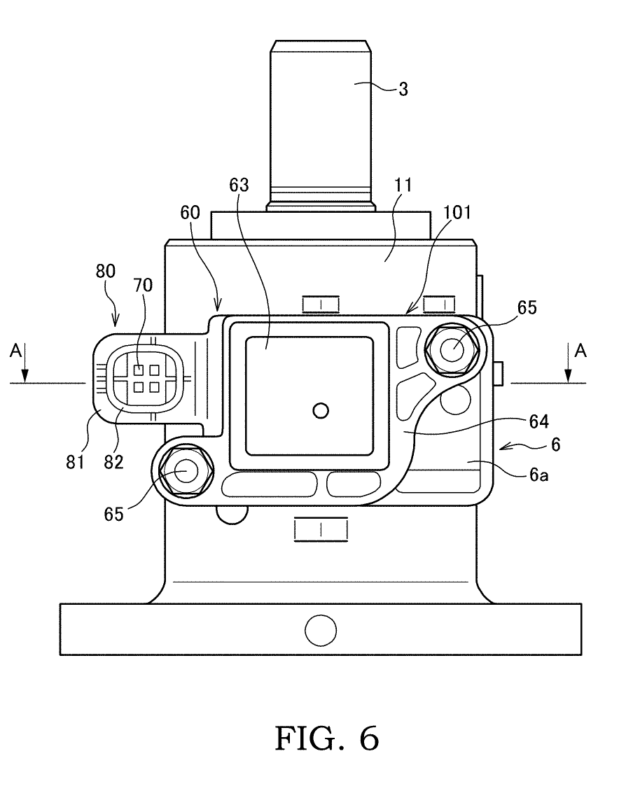

Here, since the pair of bolt insertion holes 64b are formed at the positions symmetrical with respect to the center axis C2 of the fitting portion 61, the detector assembly 101 can be attached to the first housing 11 even if vertically inverted (rotated 180°). In this case, the connector 80 is positioned on an opposite side across the fitting portion 61. Since the position of the connector 80 can be changed depending on an attachment direction of the detector assembly 101 as just described, the position of the connector 80 can be selected according to the layout of vehicle-side components. However, in this case, a pair of cutout portions 6c need to be formed at positions symmetrical with respect to a center axis of the opening portion 11a, although only one cutout portion 6c is formed in the attachment base 6 in FIGS. 6 and 7.

It should be noted that, if the attachment base 6 is formed with only one cutout portion 6c, the attachment direction of the detector assembly 101 is inevitably determined. Thus, the cutout portion 6c can be used to prevent erroneous assembling of the detector assembly 101. That is, if the position of the connector 80 is restricted due to the layout of the vehicle-side components, erroneous assembling of the detector assembly 101 can be prevented if only one cutout portion 6c is formed in accordance with the position of the connector 80.

A method for detecting a steering torque acting on the torsion bar 5 by the torque sensor 100 is described below.

In the neutral state where no torque is acting on the torsion bar 5, the first magnetic flux tip portions 31A of the first soft magnetic ring 31 and the second magnetic flux tip portions 32A of the second soft magnetic ring 32 respectively face the N and S poles of the ring magnet 22 while having the same area, thereby magnetically short-circuiting the both. Thus, a magnetic flux is not introduced to the rotating magnetic circuit unit 30 and the fixed magnetic circuit unit 40.

If a torque acts in a specific direction on the torsion bar 5 by the operation of the steering wheel by the driver, the torsion bar 5 is twisted and deformed according to the direction of this torque. If the torsion bar 5 is twisted and deformed, the first magnetic flux tip portions 31A face the magnetic poles with areas thereof facing the N poles being larger than areas thereof facing the S poles, whereas the second magnetic flux tip portions 32A face the magnetic poles with areas thereof facing the S poles being larger than areas thereof facing the N poles. The magnetic flux from the ring magnet 22 is introduced to the fixed magnetic circuit unit 40 via the rotating magnetic circuit unit 30. Specifically, this is a path of the magnetic flux from the N poles to the S poles by way of the first soft magnetic ring 31, the first magnetic flux collecting ring 41, the first magnetic flux collecting yoke 51, the second magnetic flux collecting yoke 52, the second magnetic flux collecting ring 42, and the second soft magnetic ring 32. The first and second magnetic sensors 48, 49 disposed in the magnetic gaps between the first and second magnetic flux collecting yokes 51, 52 output voltage values corresponding to the magnitude and direction of the magnetic flux.

On the other hand, if a torque acts in a direction opposite to the above one by the operation of the steering wheel by the driver, the torsion bar 5 is twisted and deformed in an opposite direction according to the direction of this torque. If the torsion bar 5 is twisted and deformed, the first magnetic flux tip portions 31A face the magnetic poles with areas thereof facing the S poles being larger than areas thereof facing the N poles, whereas the second magnetic flux tip portions 32A face the magnetic poles with areas thereof facing the N poles being larger than areas thereof facing the S poles. The magnetic flux from the ring magnet 22 is introduced to the fixed magnetic circuit unit 40 via the rotating magnetic circuit unit 30, but in a path opposite to the above one. Specifically, this is a path from the N poles to the S poles by way of the second soft magnetic ring 32, the second magnetic flux collecting ring 42, the second magnetic flux collecting yoke 52, the first magnetic flux collecting yoke 51, the first magnetic flux collecting ring 41, and the first soft magnetic ring 31. The first and second magnetic sensors 48, 49 disposed in the magnetic gaps between the first and second magnetic flux collecting yokes 51, 52 output voltage values corresponding to the magnitude and direction of the magnetic flux.

The larger the steering torque input to the steering wheel by the operation of the driver, the larger the torsional deformation amount of the torsion bar 5. Thus, a difference between the areas of the first magnetic flux tip portions 31A facing the N and S poles of the ring magnet 22 and a difference between the areas of the second magnetic flux tip portions 32A facing the N and S poles of the ring magnet 22 become larger, and the magnetic flux introduced to the magnetic gaps become larger. According to this, the output voltages of the first and second magnetic sensors 48, 49 also increase. Therefore, by increasing the number of the magnetic poles of the ring magnet 22, the density of the magnetic flux introduced to the first and second magnetic sensors 48, 49 can be enhanced.

According to the above embodiment, the following effects are exhibited.

The connector 80 is formed such that the center axis C1 thereof is offset from the center axis C2 of the fitting portion 61 in the radial direction of the torsion bar 5, and the bottom surface 80b is offset toward the first housing 11 from the contact surface 64a of the flange portion 64. By integrally forming the connector 80 with case 60 in this way, the connector 80 is formed without largely protruding in the width direction (direction perpendicular to the center axis C2 of the fitting portion 61) of the case 60 and toward the back surface side (side opposite to the first housing 11 in a direction of the center axis C2 of the fitting portion 61) of the case 60. Thus, the detector assembly 101 is compactly attached to the first housing 11. Therefore, when mounting the electric power steering device 1 into the vehicle, the interference of the detector assembly 101 with the vehicle-side components is prevented, and the mountability of the electric power steering device 1 into the vehicle is improved.

The configuration, functions, and effects of the embodiment of the present invention are summarized below.

The torque sensor 100 for detecting a torque acting on the torsion bar 5 coupling the input shaft (first shaft) 3 and the output shaft (second shaft) 4 rotatably supported in the housings 11, 12 includes the magnetic generation unit 20 configured to rotate together with the input shaft 3, the rotating magnetic circuit unit 30 configured to rotate together with the output shaft 4, and the detector assembly 101 configured to detect the density of the magnetic flux introduced from the magnetic generation unit 20 through the rotating magnetic circuit unit 30 according to torsional deformation of the torsion bar 5. The detector assembly 101 includes the magnetic sensors (magnetic detector) 48, 49 configured to detect the magnetic flux density, the board 50 connected to the magnetic sensors 48, 49, the nonmagnetic case 60 configured to house the magnetic sensors 48, 49, and the board 50 and to be attached to the housing 11, and the connector 80 configured to hold the pin 70 connected to the board 50 and integrally formed with the case 60. The case 60 includes the fitting portion 61 to be fitted into the opening portion 11a formed in the housing 11 and having the center axis C2 extending in the radial direction of the torsion bar 5 and the flange portion (brim portion) 64 extending in the direction perpendicular to the outer peripheral surface of the fitting portion 61 and to be fastened to the housing 11. The connector 80 is formed such that the center axis C1 thereof is offset from the center axis C2 of the fitting portion 61 in the radial direction of the torsion bar 5, and the bottom surface (end surface) 80b on the side opposite to the connection port 80a to be connected to the mating connector is offset toward the housing 11 from the contact surface 64a of the flange portion 64 with the housing 11.

In this configuration, since the connector 80 is formed without largely protruding from the case 60, the detector assembly 101 is compactly attached to the housing 11. Therefore, the mountability of the electric power steering device 1 into the vehicle can be improved.

Further, the connector 80 is formed such that the center axis C1 thereof is parallel to the center axis C2 of the fitting portion 61.

In this configuration, the detector assembly 101 is more compactly attached to the housing 11.

Further, a part of the pin 70 is located at the housing side with respect to the contact surface 64a of the flange portion 64.

Further, the pin 70 includes the first parallel portion 70a formed parallel to the board 50, the first perpendicular portion 70b formed perpendicular to the board 50 and extending toward the first housing 11, the second parallel portion 70c formed parallel to the board 50 and extending in the direction away from the board 50 and the second perpendicular portion 70d formed perpendicular to the board 50, and extending in the direction away from the first housing 11, wherein the second parallel portion 70c is located at the housing side with respect to the contact surface 64a of the flange portion 64.

In these configurations, the connector 80 can be arranged close to the housing 11. Thus, the protrusion of the connector 80 toward the back surface side of the case 60 can be suppressed, wherefore the detector assembly 101 is compactly attached to the housing 11.

Embodiments of this invention were described above, but the above embodiments are merely examples of applications of this invention, and the technical scope of this invention is not limited to the specific constitutions of the above embodiments.

This application claims priority based on Japanese Patent Application No. 2016-197317 filed with the Japan Patent Office on Oct. 5, 2016, the entire contents of which are incorporated into this specification.

1. A torque sensor for detecting a torque acting on a torsion bar coupling a first shaft and a second shaft rotatably supported in a housing, comprising:
a magnetic generation unit configured to rotate together with the first shaft;
a rotating magnetic circuit unit configured to rotate together with the second shaft; and
a detector assembly configured to detect a density of a magnetic flux introduced from the magnetic generation unit through the rotating magnetic circuit unit according to torsional deformation of the torsion bar;
the detector assembly including:
a magnetic detector configured to detect the magnetic flux density;
a board having the magnetic detector connected to the board;
a nonmagnetic case configured to house the magnetic detector and the board, the case being attached to the housing; and
a connector configured to hold a pin connected to the board, the connector being integrally formed with the case;
the case including:
a fitting portion configured to be fitted into an opening portion formed in the housing, the fitting portion having a center axis extending in a radial direction of the torsion bar; and
a brim portion extending in a direction perpendicular to an outer peripheral surface of the fitting portion, the brim portion being fastened to the housing; wherein
the connector is formed such that a center axis of the connector is offset from the center axis of the fitting portion in a radial direction of the torsion bar, and the connector is formed such that an end surface on a side opposite to a connection port to be connected to a mating connector is offset toward the housing from a contact surface of the brim portion with the housing.

2. The torque sensor according to claim 1, wherein:
the connector is formed such that the center axis of the connector is parallel to the center axis of the fitting portion.

3. The torque sensor according to claim 1, wherein:
a part of the pin is located at the housing side with respect to the contact surface of the brim portion.

4. The torque sensor according to claim 3, wherein:
the pin includes:
a first parallel portion formed parallel to the board;
a first perpendicular portion formed perpendicular to the board, the first perpendicular portion extending toward the housing;
a second parallel portion formed parallel to the board, the second parallel portion extending in a direction away from the board; and
a second perpendicular portion formed perpendicular to the board, the second perpendicular portion extending in a direction away from the housing; and
the second parallel portion is located at the housing side with respect to the contact surface of the brim portion.
